(19) United States
(12) Patent Application Publication
(10) Pub. No.: US 2010/0076862 A1
(43) Pub. Date: Mar. 25, 2010

(54) SYSTEM AND METHOD FOR RESERVING AND PURCHASING EVENTS

(75) Inventor: Howard Lefkowitz, Henderson, NV (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: VEGAS.COM, Henderson, NV (US)

(21) Appl. No.: 12/208,236

(22) Filed: Sep. 10, 2008

(51) Int. Cl. G06F 17/30

(52) U.S. Cl. 705/27; 707/E17.039

(57) ABSTRACT

A system and method enables a customer to purchase time-sensitive events over a computer network. Customer requests are received over the network to view events for possible purchase. The customer may be queried to determine when the customer is available to ensure that the events are available to the customer. Events are displayed to the customer in a manner to ensure that selected events do not overlap with one another. Displayed events for purchase may be filtered based on customer preferences.

### TECHNICAL FIELD

The disclosure relates to reservation systems for purchasing participation in user-attended events.

### BRIEF DESCRIPTION OF THE DRAWINGS

The various aspects and advantages are described by way of example in the following description of several embodiments and attached drawings. It should be understood that the accompanying drawings depict only typical embodiments and, as such, should not to be considered to limit the scope of the claims. The embodiments will be described and explained with specificity and detail in reference to the accompanying drawings in which:

FIG. 1 is a block diagram of one embodiment of a system to purchase and reserve events.

FIG. 2 is a block diagram illustrating potential points-of-sale (POS) interfacing, both directly and indirectly with a system.

FIG. 3 is a flow diagram illustrating steps of one embodiment of a method for reserving and purchasing events.

FIG. 4 is a block diagram illustrating a concept of “co-relation” between events.

FIG. 5 is a block diagram illustrating a concept of “co-availability” of events.

### DETAILED DESCRIPTION OF PREFERRED EMBODIMENTS

Embodiments of a method for reserving and purchasing events are described herein. In the following description, numerous details are provided to give a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring innovative aspects of this disclosure.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer-readable medium), a method, and a product of a process.

For convenience, reference is also made to users and customers which are “human parties” or “humans” to distinguish them from computer and software operations. Operation of a computer and software may be overseen by human administrators and driven by data and/or commands from human users.

Suitable networks for configuration and/or use as described here include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer may function both as a client and as a server. Each network includes at least two computers, such as the server and/or clients. A computer may be a workstation, laptop computer, disconnectable mobile computer, server, mainframe, cluster, so-called “network computer” or “thin client”, personal digital assistant or other hand-held computing device, “smart” consumer electronics device or appliance, or a combination thereof.

Each computer includes at least a processor and a memory; computers may also include various input devices and/or output devices. The processor may include a special purpose processing device, such as an ASIC, PAL, PLA, PLD, Field Programmable Gate Array, or other customized or programmable device. The memory may include static RAM, dynamic RAM, flash memory, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

At least one of the computers is capable of using a floppy drive, tape drive, optical drive, magneto-optical drive, or other means to read a storage medium. A suitable storage medium is a computer-readable storage medium including a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein. Thus, the medium tangibly embodies a program, functions, and/or instructions that are executable by computer(s) to reserve and purchase events as described herein.

Suitable software to assist in implementation is readily provided by those of skill in the pertinent art(s) using the teachings presented here and programming languages and tools, such as Java, Pascal, C++, C, XML, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used is already available, such as: general purpose computers; computer programming tools and techniques; computer networks and networking technologies; digital storage media; authentication, access control, and other security tools and techniques provided by public keys, encryption, firewalls, and/or other means; bank transfers, credit card processing, digital money, and other tools and techniques for making payments.

An event may be any activity contemplating the participation and personal attendance of a human. An event may require an advanced request to attend. Attendance requires a person to go to a designated location. An event may not require an advance reservation, such as attending a theme park or museum, but may nevertheless require a ticket. In many, but not all, instances, event attendance may require a ticket and often such a ticket is obtained only by purchase. Other events may not cost anything to attend, but may have limited space, so attendance merely requires making an advanced reservation of the limited space. Although advanced reservation to attend an event may in some cases be free, making a reservation can still be considered a purchase because even a purchase of $0.00 costs the customer time in scheduling to attend the event and time and effort spent in obtaining the reservation.

Some events are user-attended perishable events, wherein the event has an established date, time, and duration and, thus, can only be attended during that block of time. Any portion of the pre-established time during which the user is not attending the event perishes; the opportunity to attend that portion of the event has passed, and a corresponding portion of the purchase is wasted. Whether an event is perishable may be important for customers who prefer to not allow purchases to be wasted by passing unattended. Types of events may include, but are not limited to, accommodations, shows, sporting events, transportation, dining reservations, museums, tours, amusement parks, and other activities and attractions.

An accommodation event may include, but is not limited to, hotel rooms, apartment rentals, house rentals, timeshare rooms, houseboat rentals, and the like. Thus, the term accommodation includes a variety of embodiments where a customer may reside temporarily for travel. An accommodation event typically requires check-in and check-out dates, but the time of check-in and check-out is often flexible. An accommodation may also be available after the day of check-in, but a customer may have lost a portion of the event. Thus, the accommodation event may be considered perishable in that reserved days expire, and a customer/guest needs to be present on the reserved days in order to enjoy the accommodation. The accommodation may also be extended based on availability and at the discretion of the event provider.

A show event may refer to a theater show of many different varieties, including but not limited to a movie, ballet, opera, play, or a concert. A show may also refer to a show somewhere other than a theater, such as a stadium or an arena. Such shows may include, but are not limited to a circus, a fireworks display, or a show on ice (such as Disney® on Ice). A show event may include a specific date and time. The show event may also include one or more specific seats, or the show event may have open seating. As the show event occurs at a specific date and time, the show event is perishable in that the customer must be physically present at the date and time in order to enjoy the event.

A sporting event may include viewing of sporting events of many different varieties, including but not limited to a football game, baseball game, basketball game, hockey match, tennis match, motor cross, golf tournament, horse racing, and the like. A sporting event may include a specific date and time. The sporting event may also include one or more specific seats, or the sporting event may have open seating. As the sporting event occurs at a specific date and time, the sporting event is perishable in that the customer must be physically present at the date and time in order to enjoy the event.

A dining event may include, but is not limited to, a reservation at a restaurant. A dining reservation typically includes a specific date and time and is also perishable. If a customer arrives too late, the dining reservation may be cancelled, and lack of availability may preclude a customer from enjoying the dining event.

A transportation event may include, but is not limited to, airline reservations, bus tickets, train tickets, a cab ride, limousine rental, car rental, horse carriage ride, and the like. A transportation event that allows for an advanced reservation may generally be perishable in that such event requires meeting the carrier at a predetermined pick-up location at a pre-determined time. If the time for pick-up passes, the event perishes. Other transportation events may not be perishable, such as a pass to ride on a local bus system, subway, or other transit system, or a voucher for a cab ride from a particular company.

An activity event may require participation by the person attending the event and may or may not be a perishable event. Certain activities may be perishable based on the event and the event provider. For example, certain tours, skydiving, golf, river rafting, guided fishing trips, guided hunting expeditions, and the like may require specific dates and times in order to accommodate customers. Such events may be perishable. Other activity events may not require specific times and dates, such as amusement parks, water parks, theme parks, museums, ski resorts, summer resorts, zoological parks, state and national parks, water parks, and clubs. Such activity events may be open generally to the public and thus may not be perishable. Such events are not perishable if tickets to (or at least reservations to attend) the event may be usable at any time and on any date (or at least within a fairly wide range of dates) at the customer's convenience.

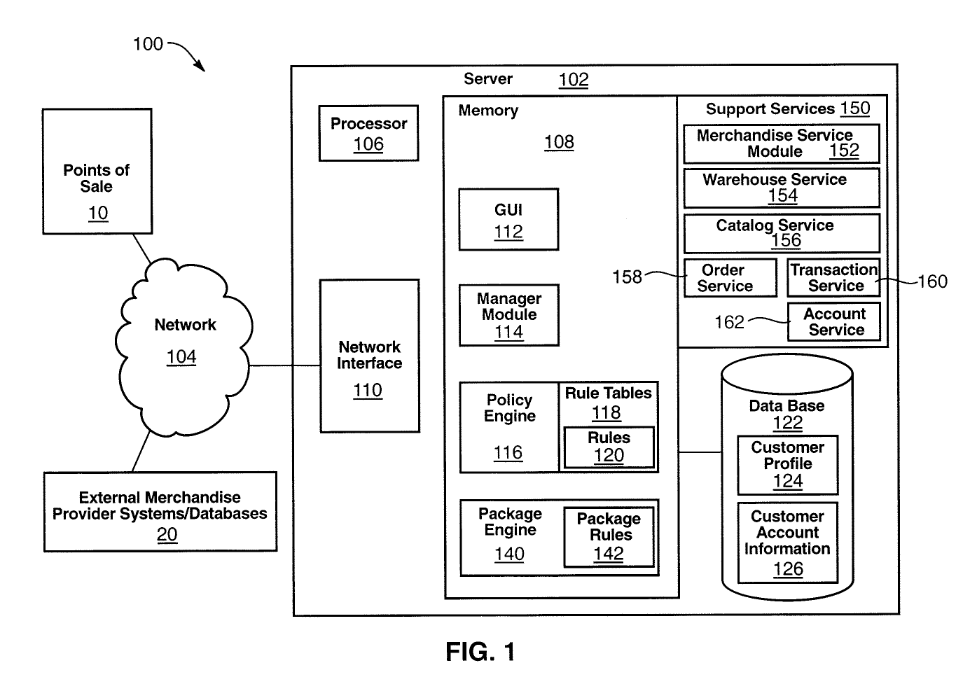

Shown in FIG. 1 is a block diagram of one embodiment of a reservation and purchase system 100. The system 100 may include a server 102 or computer accessible through a network 104, such as the networks described above. The server 102 may include a processor 106 and a memory 108 having stored thereon computer readable instructions and modules to perform the teachings described herein.

Points of sale (hereinafter “POS”) 10 may interface with the system 100 through the network 104 to reserve and purchase events. The system 100 may also interface with external merchandise provider systems 20. A merchandise provider system 20 may comprise one or more servers and one or more databases to provide information on various events.

The system 100 may comprise a network interface 110 to enable communication with the network. The system 100 may also comprise a graphical user interface (GUI) 112 to enable and facilitate selection and purchase of events. The GUI 112 may be resident in the memory 108 and may be embodied in various formats, such as being compatible with conventional web browsers. The GUI 112 may include various menus and options to allow a user to navigate through a variety of events. As can be appreciated, the number of events and options may be significant and providing a user-friendly interface greatly improves a reservation experience.

The system 100 may comprise a manager module 114 resident in the memory 108 which oversees operations and calls upon the various applications and modules as needed to enable event purchase and reservation. The system 100 may comprise a policy engine 116, resident in memory 108, which determines the events that will be viewable through the GUI 112 and available for purchase and reservation. The policy engine 116 may further determine how and in what order events are displayed to a user. The policy engine 116 may make these determinations based on various factors, such as event inventory, the POS, and the customer profile.

The policy engine 116 may include one or more rule tables 118 comprising rules 120 which are used to determine which events are available and how the events are displayed. The policy engine 116 applies rules 120 from the various tables 118 which affects which events may be displayed, reserved, and purchased. A common rule is simply event availability. As events are time-constrained products, they may be sold out for a given date and time. Thus, when a hotel is completely booked for requested dates, a lodging event at the hotel for those dates is not available for purchase.

The rule application may depend on a variety of factors including the POS 10 and the customer profile. Thus, some of the rules 120 of policy engine 116 may be pre-defined according to the POS 10, such as the location or the affiliation of the POS 10. A POS 10 may be a resort or hotel which is offering one or more specific events. As can be appreciated, the resort may wish to offer only their events or may wish to display their events in a preferential manner. Certain events may also be more profitable than other events, and the more profitable events may be displayed in a preferential manner.

Preference may be given to events by listing certain events first, highlighting events, and the like. Thus, a rule 120 may require that events specific to a POS 10 be viewed or listed preferentially when that POS 10 accesses the system 100. Rules 120 regarding a customer profile may require consideration of entertainment preferences/restrictions, the customer's previously attended events, the customer's wish list, dietary preferences, customer physical limitations, and the like.

The system 100 may include one or more databases 122 which store customer profiles 124 comprising data specific to a customer. A customer profile 124 may include enduring data which remains a part of the customer's profile until changed. Enduring data may include, but is not limited to, address, physical constraints, dietary restrictions, previously attended events, and preferences. The customer profile 124 may also include transient data which is applicable only for a particular query or session of queries. Transient data may include, but is not limited to, customer availability, customer location, desired number of events, pricing restrictions, number in party, and the like.

When a user or customer accesses the system 100 from a POS 10, the manager module 114 and GUI 112 may prompt for a login or other customer identification. The system 100 may be configured to establish customer accounts with user names and passwords. Each customer account may be associated with a customer profile 124 stored in the database 122. Thus, when logging in, the system 100 is able to retrieve a customer profile 124. Furthermore, additional customer account information 126 may be stored in the database 122, such as billing information, correspondence and contact information, and the like. As such information is highly confidential, the necessary encryption may be employed for security.

The system 100 may retrieve a customer profile 124 and customer account information 126 whether the customer logs in from a POS 10 or a user logs in on behalf of a customer from a POS 10. Logging in on behalf of a customer may occur in resorts, hotels, call centers, and the like. The manager module 114 may activate the policy engine 116 and apply certain rules 120 based on the customer profile 124. For example, if the customer is in a certain income bracket, the rules 120 may dictate that certain events be listed or otherwise viewed preferentially. If a customer has a modest income, then the rules 120 may require that preference be given to economical events. More expensive events may also be listed, but may be further down on a list, displayed on subsequent web pages, or viewed in some other non-preferential manner. A customer with a high income may have higher priced events listed or viewed preferentially. In another example, the rules 120 may dictate that customers in certain age brackets have events listed or viewed preferentially. Physically demanding events may be listed or viewed with less preference for senior citizens. Alcohol related events, such as wine tasting, may be listed or viewed with less preference for an under-age customer. The rules 120 may also dictate preference based on a customer's past purchases. If a customer often stays at a certain hotel and dines at a specific restaurant and frequently plays golf, then these corresponding event options may be displayed with preference. As can be appreciated, the rules 120 may apply any of the data in a customer profile 124 in providing preferential display.

In one embodiment, certain events which are unlikely to be selected may not be available and not listed to facilitate navigation by reducing options. Furthermore, a customer profile 124 may indicate a certain membership or privilege that allows access to exclusive events. For example, a customer may have membership in a dining club, country club, travel lounge, and the like. By virtue of such membership, a customer may be able to participate in events that are not available to the general public. In another example, a customer profile 124 may indicate that a customer is a VIP or a “high roller,” i.e., a high stakes gambler. This customer may be able to participate in gaming events in a casino which are not available to the general public.

Furthermore, the policy engine 116 may apply rules 120 based on a customer status to determine event availability. A customer status may be stored in a customer profile. The higher the customer status, the more events that may be available for display and purchase. Customer status may depend on the number of customer purchases, such as a loyalty program. Customer status may also be indicated by a unique indication in a profile 124 that a customer is a VIP.

As can be appreciated, the rules 120 reflecting event viewing and selecting may be modified as desired based on any data in customer profile.

The system 100 allows the purchase and reservation of single and multiple events, and may further provide an event package. An event package includes multiple events which are compiled by a package engine 140 to reduce user involvement in event planning. Thus, a user need not select each event, but can consider purchasing an event package. The package engine 140 attempts to provide a customized package that satisfies a user's expectations and preferences. The GUI 112 may provide an option to initiate the package engine 140.

The package engine 140 may present questions in a wizard-style user interface to be answered by the customer. The package engine 140 may gather information by presenting simple questions, or may be a more involved narrative, explaining in greater depth the significance of questions being asked and preferences that may be provided. The package engine 140 may inquire as to arrival and departure times, entertainment preferences, dining preferences, preference for the pace of a schedule, and the like. In addition to asking questions, the package engine 140 may also rely on data in a customer profile 124, if available. Thus, the customer profile 124 may supplement the customer responses.

In one embodiment, the package engine 140 may employ a software wizard to provide a questionnaire. The questionnaire prompts a user with different questions and/or preferences. Prompts for preferences may provide a scale to rank preferences and a user responds with answers and preferences. The package engine 140 may assign a weight to each answer and preference to determine suitable events, such as accommodations, shows, tours, dining, transportation and other options. In completing responses relating to accommodations, a user may indicate price preferences, geographic preferences, amenity preferences, date preferences, occupancy preferences, and the like. These preferences may be weighted by the package engine 140 and considered in selecting an accommodation. Events are searched to generate matches to the customer based on the responses. The events may then be compiled into an event package to provide a group of events for purchase.

The entering of answers and preferences may be done on behalf of a customer. For example, a hotel concierge may enter answers and preferences while assisting a hotel guest.

The package engine 140 considers responses and may apply package rules 142 or rules 120 to generate one or more event packages. A package rule 142 may require that an event package include one or more types of events. For example, a package rule 142 may require selection of an accommodation, selection of at least one show, selection of at least one dining reservation, selection of two activities, etc. Package rules 142 may require certain anticipated needs, such as transportation to and from an accommodation.

Package rules 142 may determine that by selecting other events, such as a show, activity, or dining, the location of these events may influence the selection of an accommodation. Package rules ** may dictate that an accommodation be weighted more favorably if it is located in the vicinity of one or more other activities. Likewise, other events may be weighted more favorably if they are in the vicinity of each other. For example, a dining reservation for a restaurant next door to the hotel may be weighted more favorably than a dining reservation for a restaurant several miles from the hotel. However, based on responses in a questionnaire, a dining reservation may nevertheless be weighted with a strong enough preference to overcome a geographical weighting preference.

Package rules 142 may also require selection of events from certain providers. Selection of certain provider events may be based on the POS. As can be appreciated by one of skill in the art, package rules may be established to accommodate a variety of preferences in order to please customers and event providers.

In addition to weighting preferences, the package engine 140 may confirm that the events are conveniently located to one another. Furthermore, the package engine 140 may confirm that any potentially conflicting events are co-available in that they do not overlap in time. An accommodation would not be a conflicting event with a show, dining reservation, or activity. Furthermore, the package engine 140 may confirm that the events are appropriately co-related in that there is sufficient travel time between each event.

Rather than presenting a user with options for a single event, the user is presented with an event package. The package engine 140 attempts to generate an event package that is acceptable and pleasing to the customer. The event package may be presented for purchase with a total price. The event package may be listed or viewed with other event packages for user review and comparison. Thus, the package engine 140 may provide alternative event packages in an attempt to meet a customer's expectations.

The package engine 140 may return with an event package including events selected from different event types. Each event may be favorably weighted based on the user-entered responses. A resulting event package is displayed to a user for review and possible purchase. The package engine 140 may also display a plurality of event packages, and these event packages may be ranked according to favorable matching. A user may review the event packages and manually select a preferred event package. The package may include a single price to facilitate the transaction.

An event package may also be customized based on user preferences. In one embodiment, a customer or user may deselect events, add events, or otherwise modify an event package. Thus, the event package may be considered an initial proposal of events. Selection of additional events may be performed according to the teachings disclosed herein. Accordingly, a user may be able to change one or more events. For example, if a user does not wish to attend a show, a user may deselect the show, select an alternative show, and/or request a search for an alternative show. If a user wishes to select an alternative show, the user may be directed to a listing or grouping of alternative shows that are available at approximately the same time.

By way of example, a customer may initiate the package engine 140 and indicate interest in an event package for Las Vegas. The package engine 140 may prompt for arrival and departure times and provide a questionnaire reflecting interests and preferences. The package engine 140 may then automatically generate an events package which includes lodging within the arrival and departure times, shuttles, dining reservations, show reservations, tours, free time for gaming, and the like. As used herein, the term automatically means without user intervention. Thus, although a user may initiate the package engine 140 and complete a questionnaire, the package engine 140 generates the events package. If the customer is pleased with the events package, the customer may purchase the package or perhaps modify the package if this feature is available.

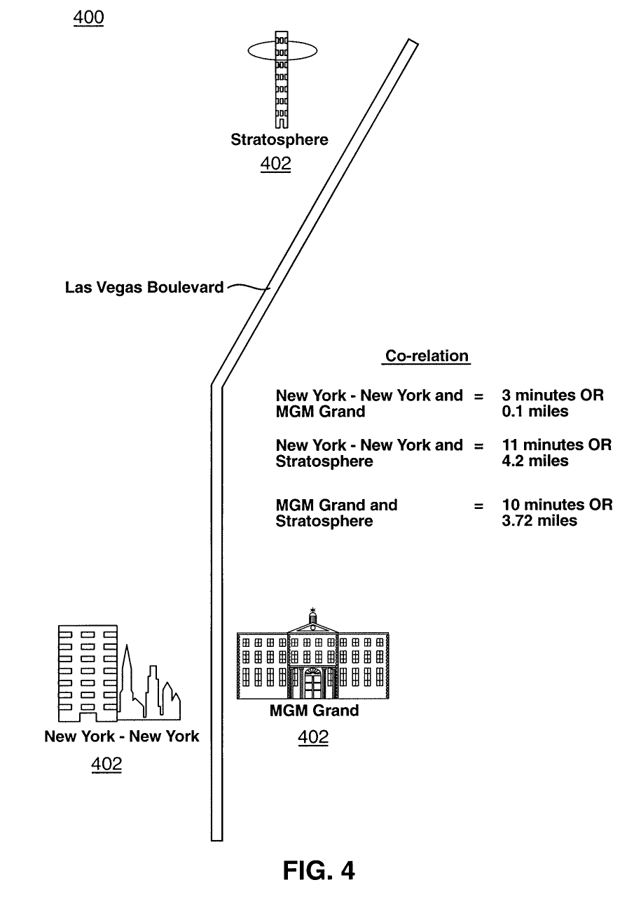

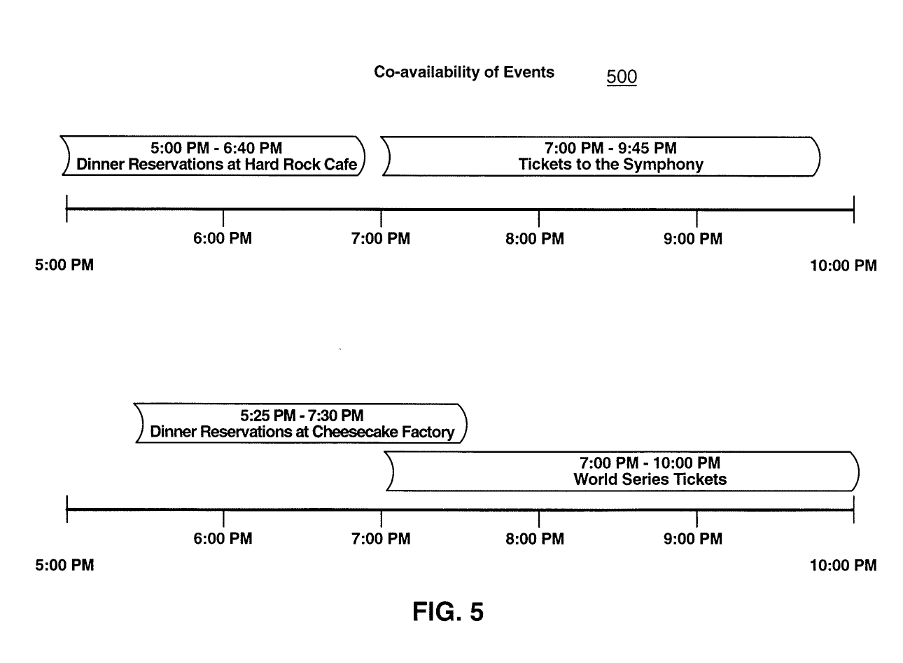

The manager module 114 may operate in communication with one or more support services 150. Support services 150 may be embodied as computer readable modules capable of performing unique assistance to the manager module 114 in offering events for sale. The support services 150 may include a merchandise service module 152 which determines the convenience and practicality of traveling between multiple events. In so doing, the merchandise service module 152 determines the co-relation and co-availability of events. This is discussed in further detail below in relation to FIGS. 4 and 5.

The support services 150 may further include a warehouse service 154 which maintains a directory of events, for purchase and reservation, that are accessible through an external provider. An external provider may maintain a warehouse which stores event inventories. The warehouse service 154 provides an interface with the external provider and warehouse to access events for purchase and reservation.

The catalog service 156 provides a description of one or more events. By selecting an event and requesting additional information, the catalog service 156 may provide the requested information.

An order service 158 provides an on-line virtual “shopping cart” to hold individually selected events or a package including a plurality of events. A transaction service 160 enables the purchase of events in the shopping cart through conventional methods, such as credit and debit cards as well as on-line accounts, such as PayPal.

The account service 162 enables the creation and management of customer accounts. Upon creation of an account, a password may be created to enable access to the account. The customer account may include billing, shipping, and correspondence information may be associated with a customer profile 124 unique to a customer. The customer account and associated information may be stored within a database 122.

The manager module 114 aggregates user behavior to note purchasing trends and behavior to thereby predict what the customer will buy. Information relating to prior purchases may be stored in a customer profile 124. The manager module 114 may organize events according to classes and display events to a customer based on a customer's purchasing behavior of events in the same class. Thus, if the customer has purchased magic show events, the merchandise engine may present magic show events. The manager module 114 may present the same magic show event purchased previously as well as alternative magic shows. As can be appreciated, live magic shows may be a class of events that appeal to a particular group of customers. The manager module 114 may also review purchasing patterns and/or a customer profile 124 and determine a customer class for a customer. The customer class may then be matched to events within a suitable class. A customer who typically purchases expensive live shows in Las Vegas would be matched to expensive live shows. Matched events are then displayed to a customer in a preferentially manner. The system provides a result that will likely please the customer and the event providers.

The illustrated support services 120 is not an exhaustive list, and many additional services may be embodied to provide e-commerce functions.

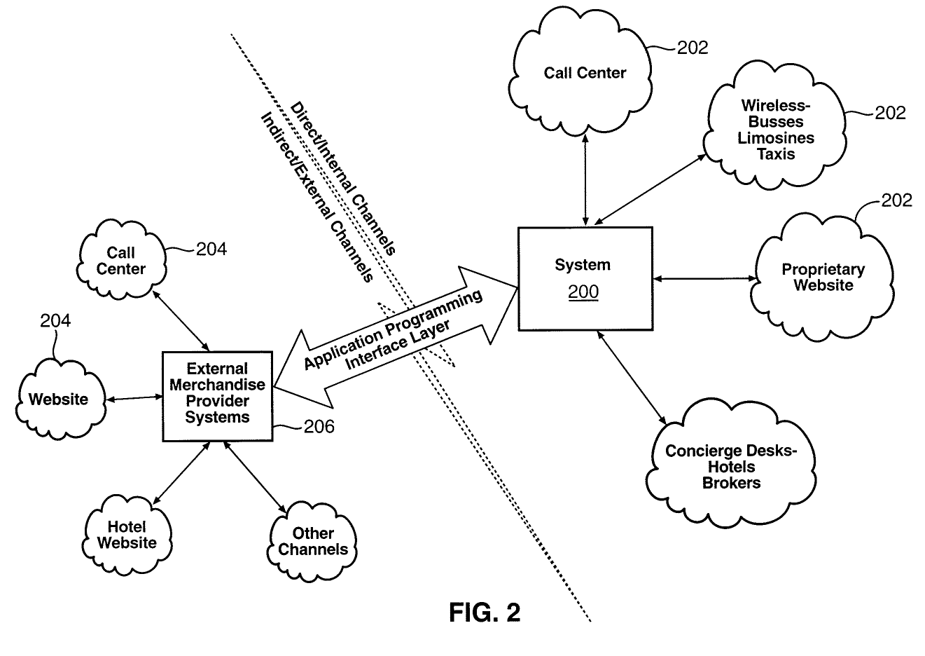

FIG. 2 illustrates a block diagram of a system 200 for purchasing and reserving events and the system's relation to various POS. FIG. 2 depicts direct, or internal, channels, wherein an internal POS 202 directly interfaces with the system 200. A POS 204 may also indirectly interface with the system 200 through indirect, or external, channels. A POS 204 may further interface with an external merchandise provider system 206 to purchase merchandise offered through the system 200 of the present disclosure.

A POS, as indicated in FIGS. 1 and 2, may be any one of a wide variety of interface devices that communicate with a system 200. Such interface devices may include, but are not limited to, a computer terminal, a telephone, or wireless device, such as a mobile phone, Blackberry, or a personal digital assistant (PDA). The interface device may be disposed at an interface location. Some examples of interface locations may include, but are not limited to: a concierge desk at a hotel accessing an embodiment via the Internet (e.g. world wide web) through a computer terminal, an automated answering service or a call center with network access to system, and a vehicle. With a vehicle, a vehicle operator, such as a chauffeur, cab driver, or bus driver, may access the system via a cell phone or via a PDA or other wireless communication device to make reservations and purchase. Alternatively, an interface device may be fixed to the vehicle for use by various passengers. In this embodiment, the interface device may not be hand-held and would require mechanical disengagement to remove the interface device from a vehicle. In a call center, operators may operate a computer terminal to access the system 200 via a network, such as the Internet.

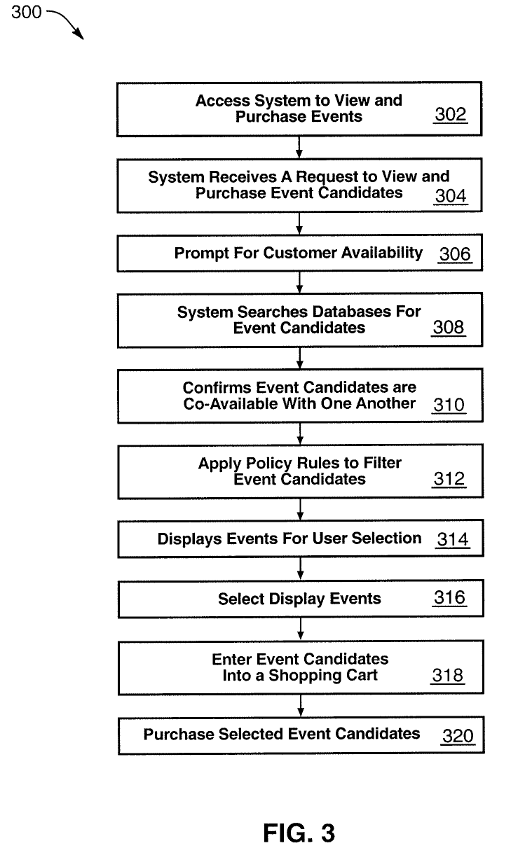

FIG. 3 depicts a flow chart illustrating a method 300 preformed by a system of the present disclosure. Certain steps may be performed in whole or in part by the manager module 114, policy engine 116, or other modules of the system 100. A user accesses 302 the system over a network to view and purchase events. The access 302 may include a log-in with a user name, password, and associated security as is well known in the art. A user accessing the system may do so on the user's behalf or on behalf of a customer.

After log-in and verification, the system receives 304 a request to view and purchase event candidates. The request may include any number of customer preferences including type of event, cost, geographical locations, and the like. The request may be received from a remote computer operating a browser application, call center, concierge, wireless device, cellular telephone, and the like. In one embodiment, a vehicle driver may operate the wireless device in a vehicle to purchase events on behalf of the customer. The vehicle driver may enter an identifier specific to the vehicle driver. The identifier may be matched to an account corresponding to the vehicle driver, and the account may be credited in reflection of any events purchased.

In one embodiment, the wireless device may be disposed within the vehicle and operated by a passenger. If the passenger operates the wireless device, an identifier corresponding to the vehicle operator may be automatically forwarded with the request. In this manner, the vehicle driver may concentrate on vehicle operation rather than be involved with any transactions.

The user or customer may also be prompted 306 for customer availability due to the time sensitive nature of the events. In response, the system may receive time and dates for a certain geographical location. For example, the customer may be in Las Vegas from November 3^{rd} through November 6^{th}. Indeed, in one embodiment, the system may prompt or otherwise receive flight information which would determine availability on the days of arrival and departure. Alternatively, the user or customer may enter availability on the days of arrival and departure.

Based on customer availability and the request, the system searches 308 one or more databases, event warehouses, and the like for event candidates that satisfy the request and the customer availability.

The system further confirms 310 that event candidates for selection are co-available with one another. In so doing, the system may display different lists, groupings, or views of event candidates. Selection of event candidates in a first plurality of event candidates may preclude selection of event candidates in a second plurality of event candidates that overlap in time. As explained subsequently, overlap may include travel time between event destinations as well. As can be appreciated, lodging reservations are an exception to time overlap for events occurring in the vicinity of the lodging. Lists, groupings, or other type of views of a plurality of event candidates may also be presented based on event type. By way of example, a first list of event candidates may display various lodging options that correspond to the customer availability. Once a lodging option is selected, it may be entered into a queue for potential purchase. Additional lodging options are not needed and are no longer displayed, unless a user wishes to modify or delete the lodging event candidate. A second list of event candidates may correspond to dining options. Once a dining option is selected for a specific data and time, a third list of event candidates may be displayed for theater events. The event candidates in the third list are co-available with the selected dining event candidate. If desired, a user may request an additional event occurring on the same day as the dining and theater event candidates. A fourth list of event candidates may be displayed that are co-available with the dining and theater event candidates. The fourth list of event candidates may be specific to a user request for another theater option, tour, or any number of various events.

In another embodiment, the system may generate a package of events that are co-available with one another. The package of events may be determined by the package engine discussed above, or determined otherwise.

As can be appreciated, certain events are not as time sensitive in that they do not occur at a specific time and then expire. For example, visiting a museum or theme park does not need to occur at a specific time although it must occur during operating hours. The available time window for certain events is considered in determining co-availability.

In determining event co-availability, the geographical relationship between event candidates may be considered. This may include determining travel intervals between a selected event candidate and other event candidates and whether a customer would be available to attend the events based on the travel intervals. Lists or other types of groupings of co-available event candidates may be generated in consideration of travel intervals with previously selected event candidates.

In determining event co-availability, the anticipated duration of an event may be considered. Some events, such as dining events, do not have fixed termination times. Accordingly, a reasonable amount of time may be considered for an event to ensure that the event is co-available with other events.

The system may further apply 312 one or more policy rules to filter event candidates. In so doing, any list or grouping of event candidates provided to user is the result of filtering. The filtering may not preclude certain event candidates, but the filtering may list or otherwise display event candidates in a preferential manner. For example, event candidates may be ranked based on a policy rule. Preferred event candidates may also be displayed before displaying non-preferred event candidates. Thus, an initial webpage showing the results of a request may only display preferred event candidates, and a user must select subsequent results to see non-preferred event candidates.

Applying the policy rules may include accessing a customer profile corresponding to the customer and applying a policy rule based on the profile. Thus, customer preferences, income, age, sex, purchasing behavior, etc., may be considered in filtering event candidates. This may be to provide event candidates that are more likely to please the customer which is more likely to result in a purchase.

As an alternative or in addition to accessing a customer profile, applying policy rules may include accessing a purchasing record of a customer's prior purchases. The event candidates may be filtered based on preferences shown in a customer's purchasing behavior.

A policy rule may also be applied based on the type of entity transmitting the request on behalf of the customer. For example, a call center or concierge may have an affiliation with a theater, dining establishment, etc. Affiliated events may be displayed in a preferential or exclusive manner. Likewise, a policy rule may be applied based on the location where the request originated. Thus, if a customer is requesting events from a hotel concierge, or other type of terminal in a hotel, events affiliated with hotel may be displayed preferentially or exclusively.

The system displays 314 events for user selection which may be performed in conjunction with both confirming 310 event co-availability and applying 312 policy rules. A user is thereby able to select 316 displayed events. As discussed, multiple lists or groupings of event candidates may be displayed to user. A first list of displayed event candidates may include event candidate that overlap in time. After selecting an event candidate from the first list, a second list of event candidates are displayed. The second list is populated with event candidates that do not overlap in time to ensure co-availability.

As an alternative to selecting event candidates from one or more lists, a user may navigate through a menu to select event candidates. The menu may include event categories which a user selects to proceed to a first plurality of event candidates. The plurality of event candidates may be arranged in a list, distributed in one or more sub-menus, or viewed in another configuration known in the art. Thus, an event category may be for theater events. After a user selects a theater event candidate, the user may proceed to a second plurality of event categories to select additional events. After selection of one event candidate from a first plurality of event candidates, only event candidates that are co-available with the selected event candidate are available for viewing and selection. Accordingly, all event candidates in a second plurality of event candidates are co-available with the selected event candidate.

In one embodiment, a first plurality of event candidates may be displayed in any number of configurations. After selection of an event candidate, the first plurality of event candidates is updated to display event candidates that are co-available with the selected event candidates. The updated plurality of event candidates may therefore be considered as a second plurality of event candidates. As can be appreciated, such operation prevents an itinerary of conflicting events and provides confidence in event scheduling.

Event candidates may be entered 318 into a “shopping cart” or other temporary storage for review and finalization. At that time, a user may view, delete, or modify the itinerary of selected event candidates. The user may then purchase 320 the selected event candidates through conventional techniques known in the art.

Referring to FIG. 4, a map 400 illustrates geographical locations of events 402 relative to one another. Co-relation refers to the geographic locations of events and the anticipated or estimated travel time between the locations of the events. It may be preferred to have a customer attend one or more events in closer co-relation to the customer's present or future location, or in closer co-relation to other events. For example, a customer may prefer to dine near the hotel where the customer is staying, and also attend a show near the hotel and the restaurant. The merchandise service module 152 disclosed in reference to FIG. 1 may consider the co-relation of potential events in these categories and then present events of the specified types having close co-relation. For example, the merchandise service module 152 may present dinner reservations and shows at the same hotel, or at proximally located hotels, on “The Strip” in Las Vegas, Nev. Events may be preferentially displayed to a customer based on co-relation. Thus, events in closer proximity to a previously selected event, may be displayed before events that are further away from a selected event.

In considering co-relation, travel time between events may be reduced and hectic commutes may be avoided. Indeed, unexpected travel conditions can cause delays which may result in being late for an event or missing the event entirely. As can be appreciated, this can greatly improve a travel experience if customers can avoid undue travel. The co-relation is only one factor that may be considered in displaying events preferentially or when including events in a package. Thus, where two otherwise equal theater events are being considered, the theater event which is closer to one or more selected events may be given a preference. The preference may be reflected in displaying an event for purchase or in including the event in a package.

In another scenario, a customer may want to attend events that are not closely co-related, but wants to ensure the events are spaced far enough apart to allow time to travel between the events. The merchandise service module 152 and/or package module 140 may consider the distance and/or time between prospective events when presenting events to the customer so as to ensure the customer is allowed ample time to travel between the events. For example, dinner reservations at a restaurant at one end of the “Strip” in Las Vegas, Nev., would be for an earlier time if preceding a show at the opposite end of the Strip, so as to allow time to travel between the two locations.

Factors considered in determining the co-relation of two events may include, but are not limited to, the mode of transportation desired and/or available and the time and day (e.g., rush hour, weekday, weekend, holiday). As shown in FIG. 4, co-relation may be quantified by minutes, distance, or other measures. Co-relation may be represented by a single measure, or may have multiple characteristics to represent different factors considered in determining co-relation. For example, two events may have one measure of co-relation for driving between the events and a different measure for walking between the events.

Referring to FIG. 5, a timeline 500 is shown to illustrate the co-availability of user-attended perishable events. In one embodiment, the merchandise service module 152 ensures that events are co-available, although this function may be performed by another module. Co-availability refers to whether events overlap in time. Co-availability may include consideration of lead time, or time from arrival at the event until beginning participation in the event. Lead time may include, but is not limited to, the time required to travel from the parking lot, bus stop, taxi drop off, or other arrival point to reserved seats at the venue. Lead time may also include time to purchase refreshments. Lead time may also include time to obtain and/or be fitted for necessary equipment to participate in the event. Lead time may further include time for socializing or networking with others before the event.

Co-availability may also include lag time, or time from the termination of participation in an event until of departure from the event. Lag time may include, but is not limited to, time required to travel from the reserved seats at the venue to the parking lot, bus stop, taxi drop off, or other departure point. Lag time may also include time to return equipment necessary to participate in the event. Lag time may further include time for socializing or networking with others after the event.

Two events that are co-available do not overlap in time such that both events may be attended. The overlap considers any lead and lag time which serve as buffers between events. Both lead and lag time may be estimated based on distances between events. The merchandise service module 152 ensures that when multiple events are purchased by the same customer, the events do not overlap in time. For example, this prevents a dining reservation in the middle of a theater event. The merchandise service module 152 and/or package module 140 may present multiple events, groupings of events, or event packages that do not overlap in time, so as to ensure the customer may attend all of the events.

Still another embodiment may consider the co-convenience of events, taking into account both the co-relation and the co-availability of events, so as to ensure not only that events in a package do not overlap in time, but also that there is sufficient lead and lag time (time before and after events) to allow for travel between the events. This embodiment would ensure, for example, that dining reservations presented are sufficiently before the start of a sporting event or a show event to allow time for the dining event as well as enough lead/lag time for the customer to travel from the restaurant to the location of the event, find parking, and arrive at the assigned seats purchased for the event. Thus, no portion of either perishable event is wasted.

By taking into account both co-relation and co-availability when determining co-convenience of events, the present disclosure allows for quick and efficient event planning and/or purchase. A customer using an embodiment of the present disclosure can more confidently (and more quickly and efficiently) schedule and purchase events because the present disclosure may prohibit a customer from purchasing conflicting events, or may at least alert the customer to potential conflicts.

It will be obvious to those having skill in the art that many changes may be made to the details of the above-described embodiments without departing from the underlying principles. Therefore, the scope should be determined only by the following claims.

1. A computer-implemented method for purchasing customer-attended events occurring at a date and time, comprising:
receiving over a computer network a request to view event candidates for purchase;
determining the availability of a customer to attend purchased events;
searching a database for event candidates related to the request;
generating a first plurality of event candidates corresponding to the request and further corresponding to the customer availability;
upon selection of a first event candidate from the first plurality of event candidates, generating a second plurality of event candidates that are co-available with the selected first event candidate based on date and time to prevent overlap of selected event candidates; and
after selection of a second event candidate from the second plurality of event candidates, providing the selected first and second event candidates for purchase.

2. The method of claim 1, further comprising:
determining the geographic relationship between the selected first event candidate and other event candidates;
determining travel intervals between the selected first event candidate and other event candidates; and
determining the availability of the customer to attend the selected first event candidate and other event candidates based on the travel intervals between events,
wherein generating a second plurality of event candidates that are co-available includes the travel intervals between the first selected event candidate and the event candidates.

3. The method of claim 1, wherein the request is received from a remote computer accessing a website.

4. The method of claim 1, wherein the request is received from a call center.

5. The method of claim 1, wherein the request is received from a concierge.

6. The method of claim 1, wherein the request is received from a wireless device.

7. The method of claim 6, further comprising:
operating the wireless device in a vehicle to purchase events;
entering an identifier into the wireless device;
receiving the identifier over the computer network;
matching the identifier to an account corresponding to a vehicle driver; and
crediting the account based on a purchase of events.

8. The method of claim 7, wherein the wireless device is a cellular telephone.

9. The method of claim 7, wherein the wireless device is coupled to the vehicle and accessible by the customer.

10. The method of claim 1 further comprising:
determining an anticipated duration of the selected first event candidate; and
determining the availability of the customer to attend subsequent events based on the anticipated duration of the selected first event candidate.

11. The method of claim 1, wherein generating the first and second plurality of event candidates comprises applying a policy rule to filter event candidates.

12. The method of claim 11, further comprising:
accessing a customer profile corresponding to the customer, and wherein the policy rule is applied based on the customer profile.

13. The method of claim 11, wherein the policy rule is applied based on the type of entity transmitting the request on behalf of the customer.

14. The method of claim 11, wherein the policy rule is applied based on the location originating the request.

15. The method of claim 11, further comprising:
ranking the first and second plurality of event candidates based on a policy rule.

16. The method of claim 15, wherein ranking the first and second plurality of event candidates based on a policy rule includes displaying preferred event candidates before displaying non-preferred event candidates.

17. The method of claim 11, wherein the policy rule is generated based on a customer profile.

18. The method of claim 17, wherein the customer profile is created based on responses of the customer to a questionnaire.

19. The method of claim 1, further comprising:
accessing a record of prior purchases that reflects purchasing behavior of the customer, and wherein generating the first and second plurality of event candidates is based on the purchasing behavior.

20. The method of claim 19, further comprising ranking the first and second plurality event candidates is based on the purchasing behavior.

21. A computer-implemented method for purchasing customer-attended events occurring at a date and time, comprising:
providing a plurality of questions to a customer, the questions including an inquiry for customer availability;
receiving responses to the questions indicative of customer preferences;
searching events based on the preferences, the customer availability, and the co-availability of the events; and
providing a package of co-available events available for purchase by the customer through a single transaction.

22. The computer-implemented method of claim 21, further comprising:
searching events based on the geographic relationship between each event;

23. The computer-implemented method of claim 22, further comprising:
determining travel intervals between each event; and
determining the availability of the customer attending events in a package based on the travel intervals between the events.

24. The method of claim 21 further comprising:
displaying the package of co-available events; and
altering the package of co-available events.

25. A computer-implemented method for purchasing customer-attended events occurring at a date and time, comprising:
receiving over a computer network a request to view event candidates for purchase;
determining the availability of a customer to attend events;
searching a database for event candidates related to the request;
generating a plurality of event candidates corresponding to the request, corresponding to the customer availability, and which are co-available with one another; and
after selection of a selected event candidate, providing the selected event candidate for purchase.
